(19) United States
(12) Patent Application Publication
(10) Pub. No.: US 2025/0250508 A1
(43) Pub. Date: Aug. 7, 2025

(54) DETERGENT COMPOSITION AND ULTRA-CONCENTRATED LIQUID LAUNDRY PRODUCT WITH QUICK DISSOLUTION SPEED

(71) Applicants: Dow Global Technologies LLC, Midland, MI (US); Rohm and Haas Company, Collegeville, PA (US)

(72) Inventors: Yang Zhang, Shanghai (CN); Cheng Shen, Shanghai (CN); Wanglin Yu, Pearland, TX (US); Aslin Izmitli, Spring City, PA (US)

(21) Appl. No.: 18/855,650

(22) PCT Filed: Apr. 15, 2022
(86) PCT No.: PCT/CN2022/087042

§ 371 Date: Oct. 10, 2024

(51) Int. Cl. C11D 1/83; C11D 1/722; C11D 17/00

(52) U.S. Cl. CPC C11D 1/83; C11D 1/722; C11D 17/0004; C11D 2111/12

(57) ABSTRACT

The present disclosure relates to a detergent composition, comprising: (a) at least one anionic surfactant; and (b) a primary alcohol-initiated nonionic surfactant having formula (I): where R′ is selected from the group consisting of a linear primary alcohol having C8-18 alkyl chain; R″ is methyl or ethyl group; x is an integer selected from 2 to 4; y is an integer selected from 1 to 30; and z is an integer selected from 1 to 50; wherein components (a) and (b) are in amount of at least 50% by weight based on the total weight of the detergent composition; and component (b) is in amount of at least 50% by weight of the sum of components (a) and (b). The detergent composition can maintain good flowability of unstructured or nonaqueous ultra-concentrated detergents as well as no gelling formation during dissolution with a reduced amount of solvents, high proportion of anionic surfactants, meanwhile, good detergency.

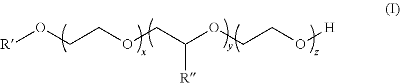

### FIELD

The present disclosure relates to a detergent composition and a ultra-concentrated liquid laundry product with quick dissolution.

### BACKGROUND

Although standard (non-concentrated) liquid laundry detergents are still dominant in some markets, concentrated liquid laundry detergents become more and more prevalent in both home care and Industrial & Institutional (I&I) cleaning applications due to the substantial consumption reduction of product packages and transportation energy. Besides, some highly concentrated liquid laundry formulations can be packaged with water soluble film, and the resulting unit dose products are burgeoning in recent years for their novel user experience. One of the key challenges to concentrate laundry detergents is to achieve good flowability of products and fast dissolution speed during dilution. Introducing solvents into formulations is the most common solution. But the solvents have no contribution to fabric cleaning. On the other hand, the proportion of anionic surfactants is usually reduced when liquid laundry formulations are concentrated to mitigate the tendency of gelling during their manufacturing and dissolution. That diminishes the freedom of formulation design and may cause the increase of cost and the compromise of performance. So it is expected that certain special surfactants can mitigate the thickening tendency of concentrated surfactant combinations and reduce the usage of solvents especially when the proportion of anionic surfactants are high in the formulations.

There are several types of concentrated liquid laundry detergents (LLDs) in mainstream markets including structured liquids, unstructured liquid and nonaqueous liquids, which are usually low-viscosity, clear, isotropic compositions containing a high amount of surfactants in conjunction with low levels of builders. Unstructured liquids are usually formulated with 30%-60% by weight of the surfactants and 30%-60% by weight of water. Nonaqueous liquids are usually formulated with 30%-80% by weight of the surfactants and less than 15% by weight of water. From the perspective of balance between cost and performance, anionic surfactants such as AES (alcohol ether sulfate) and LAS (linear alkylbenzene sulfonate), and nonionic surfactants such as linear primary alcohol ethoxylate (L-PAE) occupy an overwhelmingly large proportion of surfactant combinations. The combinations of these three surfactants tend to form high-viscosity phase at a high concentration (30-70% wt.) and form a gel phase during dilution with water. The high viscosity of formulations makes it inconvenient for manufacturing, packaging and application. Meanwhile, the high-viscosity phase forming during dissolution leads to the residue of detergents on fabric and laundry machines, blocking of dispenser pipelines, and decrease of cleaning performance.

Therefore, organic solvents such as glycols and glycol ethers are added into the formulations to reduce viscosity, maintain their handling property and shorten their dissolution time, but the organic solvents don't bring any detergency, but increase formulation cost. Another way to solve the thickening issue is adding alkoxylated nonionic surfactants such as Guerbet alcohol initiated alkoxylated nonionic surfactants. Their flowability is much better than the above-mentioned surfactants at high concentration, but their detergency is weaker compared with L-PAE. If the dosage of alkoxylated nonionic surfactants is high in concentrated compositions, the dosage of solvents can be reduced but the detergency of compositions is usually weakened as well.

Besides, reducing the ratio of anionic surfactants in concentrated liquid laundry detergents is another prevalent approach to overcome the thickening tendency. However, it diminishes the freedom of formulation design and may cause the increase of cost and the compromise of performance

Therefore, there is still an urgent request for cleaning customers to have nonionic surfactants which can maintain good flowability of unstructured or nonaqueous ultra-concentrated detergents as well as no gelling formation during dissolution with a reduced amount of organic solvents, and high proportion of anionic surfactants.

### SUMMARY

After persistent exploration, the inventors have surprisingly developed a detergent composition and ultra-concentrated liquid laundry product, which exhibits good detergency good flowability, as well as with a reduced amount of solvents and high proportion of anionic surfactants.

In a first aspect of the present disclosure, the present disclosure provides a detergent composition, comprising:
(a) at least one anionic surfactant; and
(b) at least one primary alcohol-initiated nonionic surfactant having formula (I):

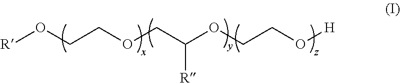

where R′ is selected from the group consisting of a linear primary alcohol having C8-18 alkyl chain; R″ is methyl or ethyl group; x is an integer selected from 2 to 4; y is an integer selected from 1 to 30; and z is an integer selected from 1 to 50;
wherein components (a) and (b) are in amount of at least 50% by weight based on the total weight of the detergent composition; and component (a) is in amount of at least 50% by weight of the sum of components (a) and (b).

In a second aspect of the present disclosure, the present disclosure provides a ultra-concentrated liquid laundry product comprising the detergent composition.

In the present disclosure, the nonionic surfactant as well as the detergent composition and liquid laundry product comprising the surfactant may exhibit improved detergency and good viscosity controlling at highly concentrated formulations. Further, they also exhibit better flowability and would not form a gel during dissolution with a reduced amount of solvents and high proportion of anionic surfactants.

It is to be understood that both the foregoing general description and the following detailed description are exemplary and explanatory only and are not restrictive of the invention, as claimed.

### BRIEF DESCRIPTION OF THE DRAWINGS

FIG. 1 is a regression analysis showing that there is a strong linear correlation between Delta P and viscosity measured by Brookfield DV-II+ Pro viscometer.

FIG. 2 is Comparison of detergency (soil removal) in unit-dose laundry detergent formulation (a/b=60/40 by weight) of Examples IE-1 to IE-10 and Comparative Examples CE-A to CE-E in the present disclosure.

### DETAILED DESCRIPTION

Unless defined otherwise, all technical and scientific terms used herein have the same meaning as commonly understood by one of ordinary skill in the art to which the invention belongs. As disclosed herein, “and/or” means “and, or as an alternative” or “additionally or alternatively”. All ranges include endpoints unless otherwise indicated.

In the present disclosure, the primary alcohol-initiated nonionic surfactant has formula (I):

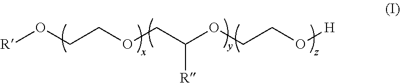

where R′ is selected from the group consisting of a linear primary alcohol having C8-18 alkyl chain; R″ is methyl or ethyl group; x is an integer selected from 2 to 4; y is an integer selected from 1 to 30; and z is an integer selected from 1 to 50.

The term “C8-18 alkyl chain” herein refers to alkyl chain having from 8 to 18 carbon atoms. In an embodiment of the present disclosure, the C8-18 alkyl chain can be selected from n-octyl, n-nonyl, n-decyl, n-undecyl, n-dodecyl, n-tridecyl, n-tetradecyl, n-pentadecyl, n-hexadecyl, n-heptadecyl, n-octadecyl or mixture thereof.

In an embodiment of the present disclosure, x is an integer selected from 2, 3 and 4. In an embodiment of the present disclosure, y is an integer selected from 1 to 30, from 1 to 25, from 1 to 20, from 1 to 16, from 1 to 12, from 1 to 9, from 1 to 4, from 4 to 30, from 4 to 25, from 4 to 20, from 4 to 16, from 4 to 12, from 4 to 9, from 9 to 30, from 9 to 25, from 9 to 20, from 9 to 16, from 9 to 12, from 12 to 30, from 12 to 25, from 12 to 20, from 12 to 16, from 16 to 30, from 16 to 25, from 16 to 20, from 20 to 30 and from 20 to 25 and from 25 to 30. In alternative embodiments of the present disclosure, y is an integer selected from 21 to 30, from 21 to 29, from 23 to 29 and from 25 to 29. In an embodiment of the present disclosure, z is an integer selected from 1 to 50, from 1 to 40, from 1 to 30, from 1 to 20, from 1 to 10, from 1 to 5, from 5 to 50, from 5 to 40, from 5 to 30, from 5 to 20, from 5 to 10, from 10 to 50, from 10 to 40, from 10 to 30, from 10 to 20, from 20 to 50, from 20 to 40, from 20 to 30, from 30 to 50, from 30 to 40 and from 40 to 50.

In an embodiment of the present disclosure, the sum of x and z is an integer selected from 3 to 54, from 3 to 50, from 3 to 40, from 3 to 30, from 3 to 20, from 3 to 10, from 3 to 5, from 5 to 54, from 5 to 50, from 5 to 40, from 5 to 30, from 5 to 20, from 5 to 10, from 10 to 54, from 10 to 50, from 10 to 40, from 10 to 30, from 10 to 25, from 10 to 20, from 10 to 15, from 15 to 54, from 15 to 50, from 15 to 40, from 15 to 30, from 15 to 25, from 15 to 20, from 20 to 54, from 20 to 50, from 20 to 40, from 20 to 30, from 20 to 25, from 25 to 54, from 25 to 50, from 25 to 40, from 25 to 30, from 30 to 54, from 30 to 50, from 30 to 40, from 40 to 54, from 40 to 50, and from 50 to 54.

In an alternative embodiment of the present disclosure, the sum of x and z is an integer selected from 8 to 30, from 8 to 25, from 8 to 20, from 8 to 15, from 8 to 10, from 10 to 30, from 10 to 25, from 10 to 20, from 10 to 15, from 15 to 30, from 15 to 25, from 15 to 20, from 20 to 30, from 20 to 25, and from 25 to 30.

In an alternative embodiment of the present disclosure, the number of y is less than that of the sum of x and z. Alternatively, y may be equal to the sum of x and z, or y may be greater than the sum of x and z. In an alternative embodiment of the present disclosure, y is greater than 8, 12, 16 or 20. In an alternative embodiment of the present disclosure, the sum of x and z is greater than 20, 24, 28 or 32.

In the present disclosure, the linear C8-18 alcohol initiated triblock nonionic surfactants can increase the concentration of anionic surfactant in the detergent composition to a level which is much higher than that in the prior art. In this regards, the inventors may apply the primary alcohol initiated nonionic surfactant to a detergent composition comprising anionic surfactants, so as to increase the total surfactant concentration and reduce solvent content. In the present disclosure, the detergent composition is characterized by at least two of (i) having less than 20 wt % (preferably, less than 15 wt %; more preferably, less than 5 wt %; most preferably, less than 1 wt %), based on weight of the detergent composition, of organic solvent, (ii) having at least 50 wt % (preferably, at least 55 wt %; more preferably, at least 60 wt %; still more preferably, at least 70 wt %; most preferably, at least 80 wt %), based on weight of the detergent composition, of surfactant, and (iii) having a viscosity of 1000 cP or less at 25° C. (as measured by HTR TADM method) and a viscosity during the process of dissolution of less than 1000 cP.

In the present disclosure, the detergent composition may comprise (a) at least one anionic surfactant; and (b) at least one primary alcohol-initiated nonionic surfactant. In the present disclosure, the detergent composition may further comprise (c) at least one organic solvent.

In an embodiment of the present disclosure, the anionic surfactants to be used in the present invention as the component (a) includes alkylsulfates, alkyl ether sulfates, alkylsulfonates, fatty acid salts, dialkylsulfosuccinates, alkylbenzenesulfonates, alkylphosphate, fatty acid soaps, and α-olefinsulfonates, though it is not particularly limited. The anionic surfactants are preferably selected from among alkylsulfates, alkyl ether sulfates, alkanesulfonates, fatty acid salts, dialkylsulfosuccinates and any combinations thereof. In an embodiment of the present disclosure, the anionic surfactants are substantially free of any intermediate polarity spacers inserted between a hydrophilic moiety and a hydrophobic moiety of the anionic surfactants. In the present disclosure, the intermediate polarity spacers generally comprise chain of propylene oxide (PO), chain of butylene oxide (BO) or any combination of ethylene oxide (EO), PO and BO in block or random order.

As to the optional organic solvents, they may be used alone in the detergent composition, or used in combination with other organic solvents in the detergent composition. In an embodiment of the present disclosure, the organic solvents may be at least one solvent selected from the group consisting of ethanol, isopropyl alcohol, propylene glycol and etc.

In an embodiment of the present disclosure, components (a) and (b) are in amount of at least 50% by weight, at least 55% by weight, at least 60% by weight, at least 70% by weight or at least 80%, based on the total weight of the detergent composition. In an alternative embodiment of the present disclosure, components (a) and (b) are in amount of greater than 50% by weight, greater than 55% by weight, greater than 60% by weight, greater than 70% by weight or greater than 80% by weight, based on the total weight of the detergent composition.

In an embodiment of the present disclosure, component (a) is in amount of at least 50% by weight, at least 55% by weight, at least 60% by weight, at least 70% by weight or at least 80% by weight of the sum of components (a) and (b). In an alternative embodiment of the present disclosure, component (a) is in amount of greater than 50% by weight, greater than 55% by weight, greater than 60% by weight, greater than 70% by weight or greater than 80% by weight of the sum of components (a) and (b).

In an embodiment of the present disclosure, the detergent composition comprises less than 20% by weight, less than 15% by weight, less than 10% by weight, less than 5% by weight, or less than 1% by weight of component (c).

In the present disclosure, the detergent composition can be diluted with water to provide a liquid laundry product. In the present disclosure, the detergent composition can contain some water, and the amount of water may be adjusted according to actual need of cleaning. In one embodiment of the present disclosure, the amount of water is generally low for highly concentrated detergent formulation. On the other hand, the unit-dose detergent formulation generally cannot contain too much water, since the packaging material of the unit-dose detergent formulation is water soluble. For example, the unit-dose detergent formulation may comprise 5-10% by weight of water.

In the present disclosure, it provides use of the detergent composition in an ultra-concentrated liquid laundry product with good flowability at high concentration, and/or quick dissolution; preferably with a viscosity of less than 1000 cP, even at a surfactant concentration of at least 50 wt % and/or a viscosity during the process of dissolution of less than 1000 cP.

The present disclosure provides the detergent composition which may deliver the following properties:
good flowability (lower viscosity of less than 1000 cP) at high surfactant concentration such as at least 50 wt % (preferably, at least 55 wt %; more preferably, at least 60 wt %; still more preferably, at least 70 wt %; most preferably, at least 80 wt % of the surfactant, based on weight of the detergent composition; and
Quick dissolution, such as lower viscosity during the process of dissolution being less than 1000 cP.

Further, the linear C8-18 primary alcohol initiated triblock nonionic surfactant comprises much longer PO chain in the structure. Besides remarkable viscosity controlling in the highly concentrated and unit-dose detergent formulations, it can effectively reduce the organic solvent usage in the formulation.

### Examples

Some embodiments of the invention will now be described in the following examples, wherein all parts and percentages are by weight unless otherwise specified.

### Inventive Examples 1-10 and Comparative Examples A-E

As shown in Table 1, the surfactants in Inventive Examples (IE) 1-10 and Comparative Examples (CE) A-E were tested or evaluated according to the measurements described below.

TABLE 1

| Example # | Description of Surfactants |
|---|---|
| IE-1 | Linear-C₁₂₋₁₄-(EO)₄-(PO)₈-(EO)₄ |
| IE-2 | Linear-C₁₂₋₁₄-(EO)₄-(PO)₈-(EO)₆ |
| IE-3 | Linear-C₁₂₋₁₄-(EO)₄-(PO)₈-(EO)₈ |
| IE-4 | Linear-C₁₂₋₁₄-(EO)₄-(PO)₈-(EO)₁₀ |
| IE-5 | Linear-C₁₂₋₁₄-(EO)₄-(PO)₈-(EO)₁₂ |
| IE-6 | Linear-C₁₂₋₁₄-(EO)₄-(PO)₁₂-(EO)₈ |
| IE-7 | Linear-C₁₂₋₁₄-(EO)₄-(PO)₁₂-(EO)₁₄ |
| IE-8 | Linear-C₁₆₋₁₈-(EO)₄-(PO)₁₄-(EO)₅ |
| IE-9 | Linear-C₁₆₋₁₈-(EO)₄-(PO)₁₄-(EO)₁₅ |
| IE-10 | Linear-C₁₆₋₁₈-(EO)₄-(PO)₁₄-(EO)₂₅ |
| CE-A | Linear-C₁₂₋₁₄-(EO)₉ |
| CE-B | Linear-C₁₂₋₁₄-(PO)₈-(EO)₉ |
| CE-C | Linear-C₁₂₋₁₄-(PO)₈-(EO)₁₁ |
| CE-D | 2-ethylhexyl-(PO)₅-(EO)₉ |
| CE-E | 2-propylheptyl-(PO)₁₋₂-(EO)₈ |

### Preparation of Detergent Formulation

Unit-dose laundry liquid detergent formulation was formulated according to the following steps:

1. Water and propylene glycol was mixed in a beaker with mechanical stirring.

2. Dodecylbenzene sulfonic acid (DBSA), sodium laureth-2 sulfate (AES), oleic acid and monoethanolamine (MEA) were added into the beaker.

3. After neutralization, one of the nonionic surfactants of IE-1 to IE-10 as well as CE-A to CE-E was was added into the beaker and the mixture was blended homogeneously.

4. The pH was adjusted to 7.5 with MEA to form a unit-dose liquid laundry detergent composition.

TABLE 2
Unit-dose laundry detergent formulation

| | | a/b = 60/40 | | a/b = 70/30 | |
|---|---|---|---|---|---|
| | | wt % | | wt % | |
| Ingredient | | Total | Active | Total | Active |
| Anionic | AES (70%) | 23.7 | 16.59 | 28.9 | 20.23 |
| surfactants | DBSA | 16.6 | 16.6 | 20.2 | 20.2 |
| (a) | Oleic acid | 10.0 | 10.0 | 10.0 | 10.0 |
| | Monoethanolamine | 4.82 | 4.82 | 5.54 | 5.54 |
| | (MEA) | | | | |
| Nonionic | IE 1-10 or | 32.0 | 32.0 | 24.0 | 24.0 |
| surfactants | CE A-E | | | | |
| (b) | | | | | |
| Solvent | Propylene glycol | 10.0 | 10.0 | 10.0 | 10.0 |
| Water | | 2.88 | 2.88 | 1.36 | 1.36 |
| Sum | | 100 | | 100.0 | |

TABLE 3
Unit-dose formulation with low dosage of solvents

| Ingredient | 8% PG | 5% PG |
|---|---|---|
| Oleic acid | 8.36 | 8.64 |
| DBSA | 18.40 | 19.00 |
| AES (70%) | 20.07 | 20.73 |
| Nonionic surfactant | 38.47 | 39.73 |
| Propylene glycol (PG) | 8.00 | 5.00 |
| MEA | 5.85 | 6.05 |
| Water | 0.85 | 0.85 |

TABLE 4
Results of dilution tests in low solvent unit dose detergents

| 8% PG UD | | | | | | | | | | | |
|---|---|---|---|---|---|---|---|---|---|---|---|
| LLDs (5 g) | +Water (g) | | | | | | | | | | |
| Surfactants | 0.25 | 0.5 | 1 | 1.5 | 2 | 2.5 | 3 | 3.5 | 4 | 4.5 | 5 |
| CE-A | Viscous | Viscous | Gel | Gel | Gel | Gel | Gel | Gel | Gel | Ge | Gel |
| CE-B | Flowable | Flowable | Gel | Gel | Gel | Viscous | Viscous | Viscous | Viscous | Viscous | Flowable |
| CE-C | Flowable | Flowable | Flowable | Flowable | Flowable | Viscous | Viscous | Gel | Gel | Gel | Gel |
| CE-D | Flowable | Flowable | Gel | Viscous | Viscous | Flowable | Flowable | Flowable | Flowable | Flowable | Flowable |
| CE-E | Flowable | Flowable | Gel | Gel | Gel | Viscous | Viscous | Flowable | Flowable | Flowable | Flowable |
| IE-1 | Flowable | Flowable | Flowable | Flowable | Flowable | Flowable | Flowable | Flowable | Flowable | Flowable | Flowable |
| IE-2 | Flowable | Flowable | Flowable | Flowable | Flowable | Flowable | Flowable | Flowable | Flowable | Flowable | Flowable |
| IE-3 | Flowable | Flowable | Flowable | Flowable | Flowable | Flowable | Flowable | Flowable | Flowable | Flowable | Flowable |
| IE-9 | Flowable | Flowable | Flowable | Flowable | Flowable | Flowable | Flowable | Flowable | Flowable | Flowable | Flowable |
| IE-10 | Flowable | Flowable | Flowable | Flowable | Flowable | Flowable | Flowable | Flowable | Flowable | Flowable | Flowable |
| 5% PG UD | | | | | | | | | | | |
| LLDs (5 g) | +Water (g) | | | | | | | | | | |
| Surfactants | 0.25 | 0.5 | 1 | 1.5 | 2 | 2.5 | 3 | 3.5 | 4 | 4.5 | 5 |
| CE-B | Flowable | Viscous | Gel | Gel | Gel | Ge | Ge | Gel | Gel | Gel | Gel |
| CE-C | Flowable | Flowable | Gel | Gel | Gel | Gel | Viscous | Viscous | Viscous | Gel | Gel |
| CE-D | Flowable | Flowable | Gel | Gel | Gel | Viscous | Viscous | Flowable | Flowable | Flowable | Flowable |
| CE-E | Flowable | Viscous | Gel | Gel | Viscous | Viscous | Viscous | Viscous | Flowable | Flowable | Flowable |
| IE-3 | Flowable | Flowable | Viscous | Flowable | Flowable | Flowable | Flowable | Flowable | Flowable | Flowable | Flowable |
| IE-10 | Flowable | Flowable | Flowable | Flowable | Flowable | Flowable | Flowable | Flowable | Flowable | Flowable | Flowable |

TABLE 5
Viscosity in unit-dose laundry detergent formulation
(a/b = 60/40 by weight) of Examples IE-1
to IE-10 and Comparative Examples CE-A to CE-E

| | Viscosity (cP) | | | |
|---|---|---|---|---|
| | Before | Adding 1 mL | Adding 2 mL | Adding 3 mL |
| Ex. | dilution | DI water | DI water | DI water |
| IE-1 | 277.1 | 249.3 | 373.7 | 294.2 |
| IE-2 | 302.9 | 281.6 | 447.8 | 283.5 |
| IE-3 | 391.1 | 350.2 | 460.9 | 182.3 |
| IE-4 | 425.9 | 385.6 | 521.1 | 206.6 |
| IE-5 | 430.5 | 404.7 | 519.3 | 170.6 |
| IE-6 | 322.2 | 257.1 | 378.4 | 258.8 |
| IE-7 | 386.5 | 329.1 | 524.1 | 284.2 |
| IE-8 | 333.5 | 238.4 | 320.8 | 211.2 |
| IE-9 | 447.2 | 384.8 | 495.1 | 124.6 |
| IE-10 | 514.2 | 435.5 | 627.2 | 159.7 |
| CE-A | 341.4 | 1428.1 | 1428.1 | 1430.3 |
| CE-B | 333.7 | 423.5 | 1424.6 | 1020.3 |
| CE-C | 374.8 | 852.6 | 1428.1 | 303 |
| CE-D | 303.5 | 405.1 | 645 | 462.5 |
| CE-E | 288.1 | 917.8 | 408.8 | 635.1 |

TABLE 6
Viscosity in unit-dose laundry detergent formulation
(a/b = 70/30 by weight) of Examples IE-1
to IE-10 and Comparative Examples CE-A to CE-E

| | Viscosity (cP) | | | |
|---|---|---|---|---|
| | Before | Adding 1 mL | Adding 2 mL | Adding 3 mL |
| Ex. | dilution | DI water | DI water | DI water |
| IE-1 | 332.5 | 313.6 | 478.1 | 506.6 |
| IE-2 | 354.7 | 284.1 | 597.2 | 466 |
| IE-3 | 423.4 | 422 | 615.5 | 299.6 |
| IE-4 | 461.2 | 477.4 | 966.8 | 302.4 |
| IE-5 | 474.6 | 635.6 | 1000.5 | 276 |
| IE-6 | 417.1 | 351 | 551.1 | 454.4 |
| IE-7 | 435.3 | 353.9 | 717.6 | 462.3 |
| IE-8 | 423.3 | 267.7 | 458.9 | 333.9 |
| IE-9 | 482.3 | 459.9 | 810.3 | 280.3 |
| IE-10 | 535.4 | 469.7 | 830.2 | 256.5 |
| CE-A | 1426.4 | 1427.8 | 329.2 | 262.8 |
| CE-B | 922.1 | 917.8 | 1425.0 | 1426.7 |
| CE-C | 687.9 | 649 | 1430.3 | 184.1 |
| CE-D | 520.5 | 724 | 750.7 | 662.2 |
| CE-E | 925.3 | 596.3 | 421.7 | 788.4 |

### Testing and Evaluation

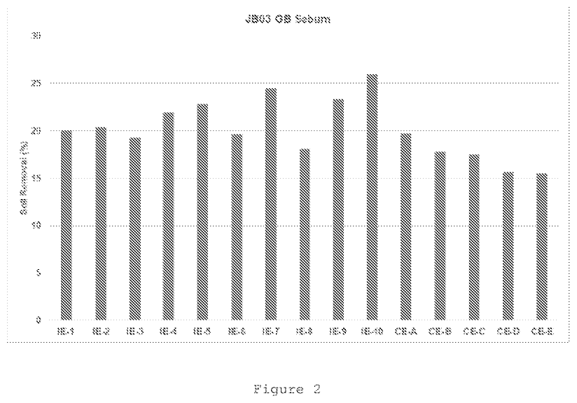

Soil removal test of concentrated and unit dose liquid laundry detergent formulations, as shown in FIG. 2

### Washing Process:

Equipment: Terg-o-tometer JB003-Sebum cloth
Dosage: 0.8 g/L
Water hardness: 250 ppm calculated by CaCO; (weight ratio—MgCl₂ 6H₂O:CaCl₂=20.37:16.7)
Temperature: 30° C.
Rotation speed: 120 rpm
Time: 20 minutes.

### GB Sebum Contains Synthetic Sebum, Gum Pigment/Cotton, Supplied by China Research Institute of Daily Chemical Industry.

### 1. Soil Removal Measurement:

Equipment: Konica Minolta spectrophotometer CM-3600A.

### 2. Procedure:

The color of dry swatches was measured by the spectrophotometer before and after washing. Each piece was measured on both sides and readings were averaged. The output of color measurement included L*, a* and b*. Detergency was calculated based on the following formula:

$$Soil removal ( \% ) = ( L * after - L * before ) / ( 96 - L * before ) * 100 \%$$

### Dilution Test of Unit Dose Detergents

5 g unit dose detergent was added into a 50 mL plastic centrifuge tube. Added 0.5 g DI water into the tube and shook it manually. After the water was mixed into the detergent, the tube was turned upside down and the flowability was measured by the time it took for the liquid to flow from the top to the bottom of the tube. The operation was repeated nine times. With respect to the flowability, the case wherein the flow time is less than two seconds is shown by “flowable”, the case wherein the flow time is more than two seconds but not exceeds five seconds is shown by “viscous”, and the case wherein the flow time exceeds five seconds is shown by “gel”.

### Viscosity Measurement During Dissolution

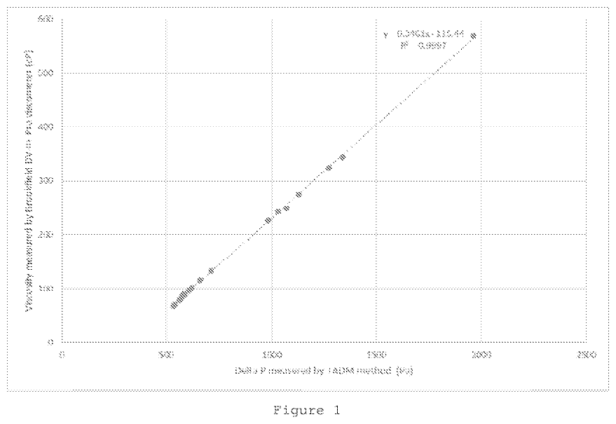

The initial viscosity and the viscosity during dissolution was measured by using the TADM (Total Aspiration and Dispense Monitoring) function on the Hamilton MicroLab Star liquid handling robot at 20° C. The Hamliton aspirates and dispenses the samples at a set speed, and monitors the pressure changes. Calibrations curves are generated using known viscosity standards. And viscosity is calculated by comparing the pressure curves of the samples against the pressure curves of viscosity standards. The data collected by TADM method was delta P. In this invention, the viscosity was calculated according to the formula: Viscosity=0.3461×delta P−115.44. In FIG. 1, the regression analysis shows that there is a strong linear correlation between Delta P and viscosity measured by Brookfield DV-II+ Pro viscometer. 2 mL unit dose formulations were added into 8 mL glass tubes and their initial viscosity was measured

After viscosity measurement, 1 mL deionized water was added into the tubes and the mixtures were mixed until homogeneous. Then, their viscosity was measured by TADM method again. The process of water addition and viscosity measurement was repeated two times until 3 mL deionized water was mixed into unit dose formulations.

Based on above Inventive Examples comparing with Comparative Examples, it was found that:

1. The formulations in Table 2 contained very high total surfactant contents at 80% by weight in the unit-dose formulations; in contrast, the solvent amount (propylene glycol) and water content were at 10% by weight and 2.88% by weight, respectively. In addition, the formulation contains very high content of anionic surfactants at 60% and 70% based on the total weight of surfactants.

2. In FIG. 2, majority of surfactants of IE 1-10 offered the unit dose formulations with better detergency than comparative surfactants did.

3. The formulations in Table 3 contained reduced dosage of propylene glycol. The content of anionic surfactants is about 55% based on the total weight of surfactants.

4. In Table 4, some surfactants of IE 1-10 made the low-solvent unit dose formulations flowable at 20° C. and no high viscosity phase was observed during dilution with water. However, all the formulations of Comparative Examples had gel formation during dilution.

5. In Tables 5 and 6, the surfactants of IE 1-10 offered the unit dose formulations with viscosity lower than 1000 cP and no high viscosity phase (>1000 cP) was observed during dilution with water. High viscosity phase was observed when the unit dose formulations containing CE-A, CE-B or CE-C were diluted.

Based on all the above performance comparison, the EO-PO-EO triblock surfactants of the present disclosure exhibited excellent anti-gelling performance in concentrated liquid laundry detergent formulations. Using them to formulate concentrated detergent formulations can reduce organic solvent content as well as keep good flowability and quick dissolution.

1. A detergent composition, comprising:
(a) at least one anionic surfactant; and
(b) a primary alcohol-initiated nonionic surfactant having formula (I): 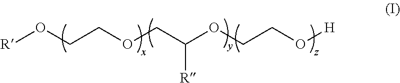
Where R′ is selected from the group consisting of a linear primary alcohol having C8-18 alkyl chain; R″ is methyl or ethyl group; x is an integer selected from 2 to 4; y is an integer selected from 1 to 30; and z is an integer selected from 1 to 50;
wherein components (a) and (b) are in amount of at least 50% by weight based on the total weight of the detergent composition; and component (a) is in amount of at least 50% by weight of the sum of components (a) and (b).

2. The detergent composition according to claim 1, wherein y is an integer selected from 8 to 25; and the sum of x and z is an integer selected from 8 to 30.

3. The detergent composition according to claim 1, wherein y is an integer selected from 8 to 16; and the sum of x and z is an integer selected from 8 to 20.

4. The detergent composition according to claim 1, wherein components (a) and (b) are in amount of at least 70% by weight, based on the total weight of the detergent composition.

5. The detergent composition according to claim 1, wherein component (a) is in amount of at least 60% by weight of the sum of components (a) and (b).

6. The detergent composition according to claim 1, wherein the detergent composition further comprises (c) an organic solvent.

7. The detergent composition according to claim 6, wherein the detergent composition comprises less than 20% by weight of component (c).

8. The detergent composition according to claim 1, wherein the anionic surfactant is selected from alkylsulfates, alkyl ether sulfates, alkanesulfonates, fatty acid salts, dialkylsulfosuccinates and any combinations thereof.

9. The detergent composition according to claim 1, wherein the anionic surfactant is substantially free of any intermediate polarity spacer inserted between a hydrophilic moiety and a hydrophobic moiety of the anionic surfactant.

10. The detergent composition according to claim 9, wherein the intermediate polarity spacer comprises chain of propylene oxide (PO), chain of butylene oxide (BO) or any combination of ethylene oxide (EO), PO and BO in block or random order.

11. A ultra-concentrated liquid laundry product comprising the detergent composition according to claim 1.
